(19) United States
(12) Patent Application Publication
(10) Pub. No.: US 2008/0244147 A1
(43) Pub. Date: Oct. 2, 2008

(54) Device Recognition Circuit and the Method of Recognition

(75) Inventor: Kun-Fu Chen, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Inventec Corporation, Taipei City (TW)

(21) Appl. No.: 11/693,015

(22) Filed: Mar. 29, 2007

(51) Int. Cl. G06F 13/20

(52) U.S. Cl. 710/313

(57) ABSTRACT

A device recognition circuit for initiating a computer system includes an adapter module and a control module. The adapter module is capable of connecting a peripheral interface card the adapter module having I/O ports, the I/O ports carry present signals generated by the adapter module. The control module having general purpose input/output (GPIO) pins for receiving the present signals, wherein the control module determines an expansion type of the adapter module according to the present signals. The embodiment of present invention also provides a method of recognizing a device for initiating a computer system.

### BACKGROUND

1. Field of Invention

The present invention relates to a device recognition circuit. More particularly, the present invention relates to a device recognition circuit for initializing a computer system and the method of recognition.

2. Description of Related Art

Peripheral Component Interconnect (PCI) is an add-on interface for computer system platforms, and the computer central processor may communicate with an external circuit board through which peripheral interface cards may be connected to the motherboard. The PCI standardized a set of specifications for data communications between the peripheral interface cards and the central processor. However, as technology advances, the PCI standard continues to evolve and expand to standards such as the PCI express (PCI-E), which is an expansion of the PCI structure with addition functions enabling faster data rate than the original PCI.

One of the advantages of PCI-E is that it supports peripheral interface cards with different slot sizes, for example, circuit boards with slot size of x1, x4, x8, and x16. In real applications, peripheral interface cards with a wider slot will be compatible with peripheral interface cards with a smaller slot size. For example, a x16 slot will be able to fit cards with slot sizes of x1, x4, and x8. However, due to the variation in slot sizes and compatibilities, difficulties arise in recognizing the various riser cards for initializing the computer system.

Conventionally, each riser card posses an unique identification (ID) signal indicative of the expansion type of the riser card. Please refer to FIG. 1, a block diagram of the interconnection between the control module 102 on the motherboard, the riser card 104 and the peripheral interface device 106. The riser card 104 has board ID pins 110 as a hardware strapping option to provide the board ID signal to the control module 102 through the interface slot 108. The control module 102 detects the board ID pins 110 plugged into the interface slot 108 to determine the type of the riser card. The necessity of the board ID pins 110 increases the pin count of both the riser card 104 and the interface slot 108, which also introduces complexity in the riser card and the related circuitry.

Therefore, a new device recognition circuit is needed to provide the control module with adequate data to recognize the riser card, but eliminate the use of the board ID pins.

### SUMMARY

The embodiment of the present invention is directed to a device recognition circuit, that it satisfies this need of recognizing a device for initializing a computer system. The device recognition circuit comprises an adapter module and a control module. The adapter module such as a riser card is capable of connecting peripheral interface cards. The riser card has I/O ports, the I/O ports carries present signals generated by the adapter module. The control module has general purpose input/output (GPIO) pins for receiving the present signals, wherein the control module determines an expansion type of the adapter module according to the present signal. The present signal is a pre-defined signal originally included in the specification of the riser card such as a PCI-E riser card. Furthermore, the embodiment of the present invention includes an initialization module for initializing the computer system according to the extension type of the adapter module. The initialization module may be the basic input/output system (BIOS) of the computer.

Lastly, a method is provided in the embodiment of the present invention for device recognition during initialization of a computer system. The method includes generating a present signal from an adapter module such as a riser card, indicative of one of the peripheral interface cards plugged into a slot of the adapter module, respectively. Next, detecting the present signal by general purpose input/output pins (GPIO) of a control module. Finally, determining an expansion type of the adapter module by the control module according to the present signal.

The objective of the embodiment of the present invention is to provide a device recognition circuit and method of recognition for initializing a computer system. The advantage of the disclosed circuit and method is to allow the pin count to be reduced on a riser card and also reduce the complicated circuitry to process individual board ID signals. The embodiments of the present invention uses a pre-defined signal such as a present signal to serve as the board ID of the riser card and thus the riser card can be recognized by the present signal indicative of the number of I/O ports and the type of I/O ports on the riser card.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram of the interconnection between a control module, a riser card and a peripheral interface device;

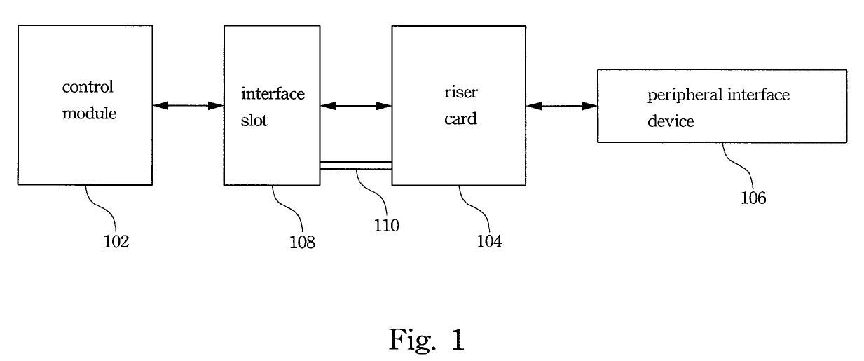

FIG. 2 is a block diagram of a device recognition circuit according to an embodiment of the present invention; and

FIG. 3 is a flow chart of the method of recognizing a device for initializing a computer system according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

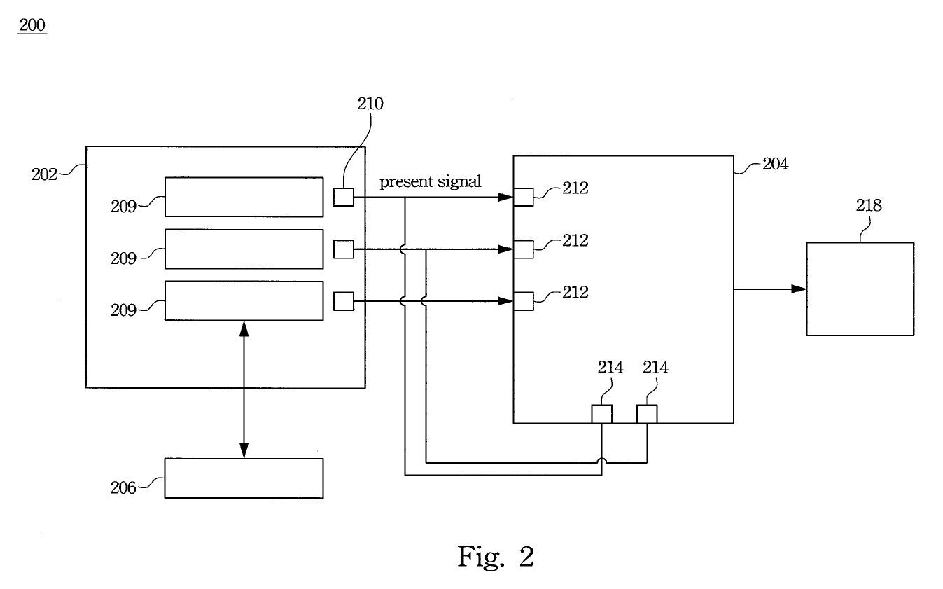

Please refer to FIG. 2, a block diagram of a device recognition circuit according to an embodiment of the present invention. The device recognition circuit 200 includes an adapter module 202, and a control module 204. The adapter module 202 may be a riser card, namely, a PCI-E riser card. The riser card may also be a mini peripheral component interconnect (mini PCI) riser card, a compact peripheral component interconnect (compact PCI) riser card, or a cardbus riser card. The adapter module 202 is capable of connecting a peripheral interface card 206. The peripheral interface card 206 is plugged into a slot 208, such as a PCI-E x8 slot, of the adapter module 202. I/O ports 209 with the same pin configuration as the slot 208 carries present signals generated by the adapter module 202. The present signals serve as board ID signals used to identify the expansion type of the adaptor module 202. The present signal may be generated by an input/output controller 210 accompanying each I/O port 209 on the adapter module 202. The present signal is a pre-defined, standard signal in the PCI-E riser card specifications. The present signals from the I/O ports 209 are routed to the general purpose input/output (GPIO) pins 214 of the control module 204, respectively. The GPIO pins 214 are defined to correspond to the present signals respectively for determining the expansion type of the adapter module. The board ID signals detected from the GPIO pins 214 are therefore composed of the logic combination present signals. The expansion type of the adapter module refers to the number of I/O ports on the adaptor module 202 and the type of I/O ports on the adaptor module 202. Please refer to the following Table 1 for an example of the algorithm:

TABLE 1

| PE3 (PCI-E x4) | PE4 (PCI-E x4) | | |
|---|---|---|---|
| Board ID bit1 | Board ID bit0 | PE5 (PCI-E x8) | Board ID |
| Device 1 | None | SLOT | 01 |
| Device 2 | Device 2 | SLOT | 00 |
| None | None | SLOT | 11 |

In Table 1, when the PE3 I/O port is present but not the PE4 I/O port (PE5 slot is the slot for connecting the peripheral device), thus the present signal of PE3 is a logic 0 while the present signal of PE3 is a logic 1. The present signals of PE3 and the present signal of PE4 provides a 2 bit board ID to recognize the expansion type of the adapter module 202. Therefore, a dedicated board ID signal is no longer necessary since the present signals from a pre-existing pin of the I/O ports are used as the board ID signal to determine the number of I/O ports on the adaptor module 202 and the type of I/O ports on the adaptor module 202.

In addition, the device recognition circuit may further include an initialization module 218 for initializing the computer system according to the expansion type of the adapter module 202. The initialization module may be the BIOS of the computer system acknowledging the expansion type of the adapter module 202 and initializing the computer system during the initial operation of the computer system.

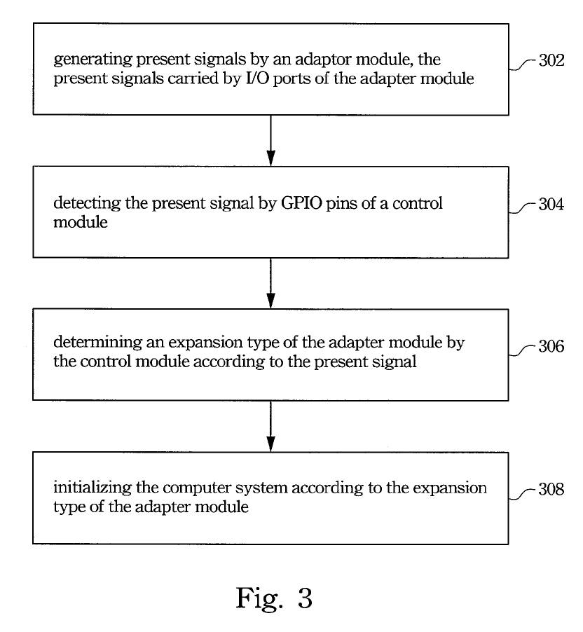

The embodiment of the present invention also provides a method of recognizing a device for initializing a computer system. Please refer to FIG. 3, a flow chart of the method of recognizing a device for initializing a computer system according to an embodiment of the present invention. The method includes the steps of a signal generating step 302, a signal detecting step 304, and a expansion type determining step 306. In the signal generating step, present signals generated by the adapter module and carried by I/O ports of the adapter module. In the signal detecting step 304, the present signal is received by general purpose input/output pins (GPIO) of a control module. Lastly, in the expansion type determining step 306, the expansion type of the adapter module is determined by the control module according to the present signal. The method of recognizing a device for initializing a computer system may also include an initialization step 308, and once the expansion type of the adapter module is determined, the BIOS of the computer system takes the result and initializes the computer system accordingly.

The embodiment of the present invention provides a device recognition circuit and the method of recognition. The device recognition circuit takes the pre-defined present signals of an adapter module such as a PCI-E riser card and connect the present signals to the GPIO pins of a control module, thus allows the computer system to determine the expansion type of the adapter module without additional hardwire pins, rather, using the present signals to identify the presence of peripheral interface devices on an adapter module and the number of slots on the adapter module.

It will be apparent to those skilled in the art that various modifications and variations can be made to the structure of the embodiment of the present invention without departing from the scope or spirit of the invention. In view of the foregoing, it is intended that the embodiment of the present invention cover modifications and variations of this invention provided they fall within the scope of the following claims and their equivalents.

What is claimed is:

1. A device recognition circuit for initiating a computer system, comprising:
an adapter module capable of connecting a peripheral interface card, the adapter module having a plurality of I/O ports, the I/O ports carrying present signals generated by the adapter module; and
a control module having general purpose input/output (GPIO) pins for receiving the present signals, wherein the control module determines an expansion type of the adapter module according to the present signals.

2. The device recognition circuit of claim 1, wherein the adapter module is a riser card.

3. The device recognition circuit of claim 2, wherein riser card is, a peripheral component interconnect express (PCI-E) riser card, a mini peripheral component interconnect (mini PCI) riser card, a compact peripheral component interconnect (compact PCI) riser card, or a cardbus riser card.

4. The device recognition circuit of claim 1, wherein the present signal is generated by an input/output controller of the adapter module.

5. The device recognition circuit of claim 1, wherein the control module defines the GPIO pins to correspond to the present signals respectively for determining the expansion type of the adapter module.

6. The device recognition circuit of claim 1, wherein the control module further comprises an initialization module for initializing the computer system according to the expansion type of the adapter module.

7. The device recognition circuit of claim 6, wherein the initialization module is a basic input/output system (BIOS) module.

8. The device recognition circuit of claim 1, wherein the I/O port has the same pin configuration as an adapter module slot.

9. The device recognition circuit of claim 8, wherein the expansion type of the adapter module is classified by the number of I/O ports on the adapter module and the type of I/O ports on the adapter module.

10. A method of recognizing a device for initializing a computer system, comprising the steps of:
generating present signals by an adaptor module, the present signals carried by a plurality of I/O ports of the adapter module;
detecting the present signal by general purpose input/output (GPIO) pins of a control module; and
determining an expansion type of the adapter module by the control module according to the present signal.

11. The method of claim 10, wherein the adapter module is a riser card.

12. The method of claim 11, wherein the riser card is a peripheral component interconnect express (PCI-E) riser card, a mini peripheral component interconnect (mini PCI) riser card, a compact peripheral component interconnect (compact PCI) riser card, or a cardbus riser card.

13. The method of claim 10, wherein the control module defines the GPIO pins to correspond to the present signals respectively for determining the expansion type of the adapter module.

14. The method of claim 13, wherein the expansion type of the adapter module is classified by the number of I/O ports on the adapter module and the type of I/O ports on the adapter module.

15. The method of claim 10, wherein the I/O port has the same pin configuration as an adaptor module slot.

16. The method of claim 10, wherein the method of recognizing a device for initializing a computer system further comprises initializing the computer system according to the expansion type of the adapter module.
